(19) United States
(12) Patent Application Publication
(10) Pub. No.: US 2018/0102204 A1
(43) Pub. Date: Apr. 12, 2018

(54) CABLE HAVING TWO INSULATIVE ELECTRIC WIRES AND TWO NON-CIRCULAR DRAIN WIRES ARRANGED IN A LINE

(71) Applicant: FOXCONN INTERCONNECT TECHNOLOGY LIMITED, Grand Cayman (KY)

(72) Inventors: JIAN LI, Kunshan (CN); HONG-PING WANG, Kunshan (CN); LU-YU CHANG, New Taipei (TW)

(21) Appl. No.: 15/729,577

(22) Filed: Oct. 10, 2017

(30) Foreign Application Priority Data
Oct. 10, 2016 (CN) 201621107317.6

(51) Int. Cl. H01B 11/18; H01B 11/20; H01B 7/17

(52) U.S. Cl. CPC H01B 11/1808; H01B 7/17; H01B 11/20

(57) ABSTRACT

A cable includes two insulated electric wires, two non-circular drain wires disposed on two opposite outer sides of the two insulated electric wires, a shield conductor wound around the two insulated electric wires and the two drain wires, and a jacket jacketing the shield conductor, wherein the two drain wires and the two insulated electric wires are arranged in a line.

### BACKGROUND OF THE INVENTION

### 1. Field of the Invention

The present invention relates to a twinax cable including two insulated electric wires and two non-circular drain wires disposed on two opposite sides of the two insulated electric wires.

### 2. Description of Related Art

U.S. Pat. No. 8,440,910 depicts a conventional twinax cable design including two signal transmission conductor wires insulated by insulating members, respectively, to provide two insulated electric wires, a shield conductor wound around the two insulated electric wires, and a rectangular drain wire lengthwise provided between the shield conductor and the insulated electric wires. An outer surface of the shield conductor is jacketed with a protective jacket. The drain wire having a non-circular cross section is used so as to reduce displacement (location gap) of the drain wire.

Drain wires of a different construction and arrangement are desired.

### SUMMARY OF THE INVENTION

A cable comprises: two insulated electric wires; two non-circular drain wires disposed on two opposite outer sides of the two insulated electric wires; a shield conductor wound around the two insulated electric wires and the two drain wires; and a jacket jacketing the shield conductor; wherein the two drain wires and the two insulated electric wires are arranged in a line.

### BRIEF DESCRIPTION OF THE DRAWINGS

FIG. 1 is a cross-sectional view of a cable in accordance with a first embodiment of the present invention; and

FIG. 2 is cross-sectional view of a cable in accordance with a second embodiment of the present invention.

### DETAILED DESCRIPTION OF THE PREFERRED EMBODIMENT

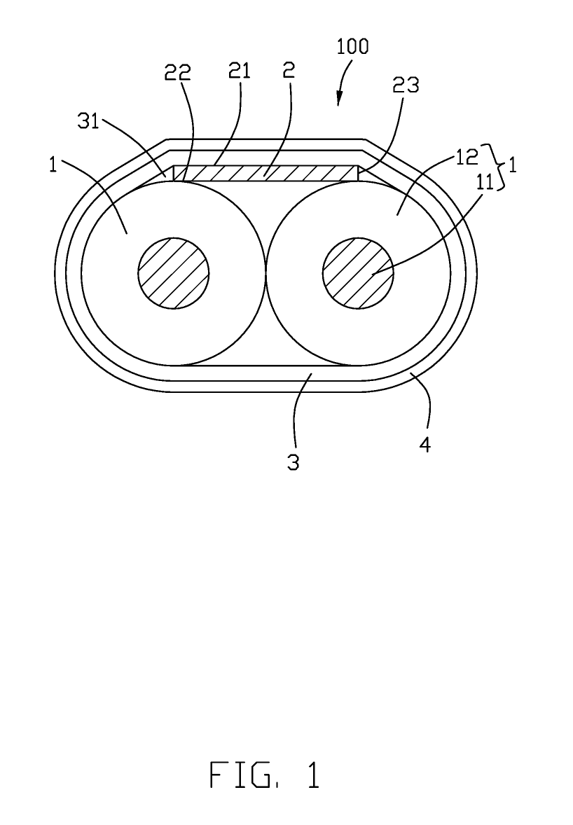

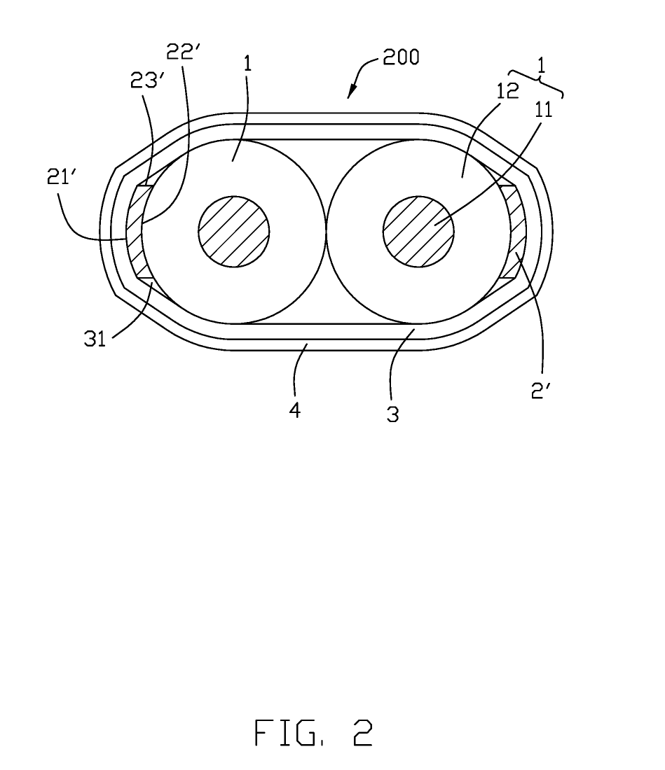

The present invention relates but is not limited to MINI SAS (Serial Attached SCSI) cable 100 or 200. The cable may have a single drain wire (FIG. 1) or a pair of drain wires (FIG. 2). The cable 100 includes two insulated electric wires 1, one drain wire 2, a shield conductor 3 wound around the two insulated electric wires and the drain wire, and a jacket 4 jacketing the shield conductor. The cable 200 includes two insulated electric wires 1, two drain wires 2′, a metallic shield conductor 3 wound around the two insulated electric wires and the drain wire, and a jacket 4 jacketing the shield conductor.

The insulated electric wire 1 is circular and has an inner conductor 11 and an outer insulation 12. The drain wires 2 and 2′ are in electrical connection to the shield conductor 3. The shield conductor 3 is made of aluminum and maybe in the form of metal foil tape. The drain wires 2 and 2′ are generally flat, i.e., non-circular, and are stably retained between the outer insulation 12 of the insulated electric wire 1 and the shield conductor 3.

Referring specifically to FIG. 1, the drain wire 2 has a rectangular cross-section and is disposed in a space 31. The drain wire 2 has a first surface 21 distal from the insulated electric wires 1, a second surface 22 proximal to and in contact with the insulated electric wires 1, and two opposite side surfaces 23. The corners between the first surface and the side surfaces firmly abut the shield conductor 3 t reduce displacement of the drain wire 2. In this embodiment, the two isolated electric wires 1 are discrete from each other and each of the two insolated electric wires 1 has a same circular cross-section, wherein the dimension of the drain wire 2 in the transverse direction is essentially similar to the distance between the corresponding center points of these two isolated electric wires 2 and thus the drain wire 2 is aligned, in the vertical direction, with such a distance between those two center points. Without this specific arrangement, the drain wire 2 may not be easily slipped away from its correct position, but being aligned, in the vertical direction, with the range defined between the two center points.

Referring specifically to FIG. 2, the two drain wires 2′ and the two insulated electric wires 1 are arranged in a line. The two drain wires 2′ are disposed on two opposite outer sides of the two insulated electric wires 1. Each drain wire 2′ is curved and concentric with associated electric wire 1. Distal first surface 21′ and proximal second surface 22′ are curved in the same way and amount. Side surfaces 23′ are also straight to form corners with the first surface 21′. The dimension of each drain wire 2′ in the vertical direction is larger than a diameter of the inner connector 11 while smaller than a diameter of the outer insulation 12 and similar to a radius of the outer insulation 12. Therefore, the angle defined between two opposite ends of the drain wire 2′ with regard to the center point of the corresponding insolated electric wire 1, is around 60 degrees. With this specific arrangement, the drain wire 2′ may not be easily slipped away from its correct position, but being symmetrical with regard to the center point in the transverse direction.

What is claimed is:

1. A cable comprising:
two insulated electric wires;
two non-circular drain wires disposed on two opposite outer sides of the two insulated electric wires;
a shield conductor wound around the two insulated electric wires and the two drain wires; and
a jacket jacketing the shield conductor; wherein
the two drain wires and the two insulated electric wires are arranged in a line.

2. The cable as claimed in claim 1, wherein the drain wire is curved and concentric with the associated electric wire.

3. A cable comprising:
a pair of insulated electric wires side by side intimately disposed with each other in a transverse direction, each of said insulated electric wire having an inner conductor and an outer insulation concentrically arranged with each other;
a flat drain wire extending along the transverse direction and intimately disposed on one side of said pair of insulated electric wires in a vertical direction perpendicular to said transverse direction;
a metallic shielded conductor intimately surrounding both said pair of insulated electric wires and said flat drain; and
an insulative jacket intimately surrounding said shielded conductor; wherein
a dimension of said flat drain wire in said transverse direction is similar to a diameter of the insulated electric wire, and is aligned with a ranged defined between two corresponding center points of said pair of insulated electric wires in the vertical direction.

4. A cable comprising:
a pair of insulated electric wires side by side intimately disposed with each other in a transverse direction, each of said insulated electric wire having an inner conductor and an outer insulation concentrically arranged with each other;
a pair of sheet type drain wires intimately dispose upon two opposite outer sides of said pair of insulated electric wires along said transverse direction, respectively;
a metallic shielded conductor intimately surrounding both said pair of insulated electric wires and said pair of sheet type drain wires;
an insulative jacket surrounding said shielded conductor; wherein
said sheet type drain wire intimately curvedly disposed upon the corresponding insulated electric wire.

5. The cable as claimed in claim 4, wherein a dimension of said sheet type drain wire is larger than a diameter of the inner conductor while smaller than a diameter of the outer insulation and similar to a radius of said outer insulation.

6. The cable as claimed in claim 4, wherein an angle defined between the two opposite ends of each of said sheet type drain wire with regard to a corresponding center point of the neighboring insulated electric wire is around 60 degrees.
